(19) United States
(12) Patent Application Publication
(10) Pub. No.: US 2013/0257809 A1
(43) Pub. Date: Oct. 3, 2013

(54) OPTICAL TOUCH SENSING APPARATUS

(71) Applicants: Shou-Te Wei, New Taipei City (TW); Chia-Te Chou, New Taipei City (TW); Kou-Hsien Lu, New Taipei City (TW); Chun-Wei Wang, New Taipei City (TW); Yu-Yen Chen, New Taipei City (TW)

(72) Inventors: Shou-Te Wei, New Taipei City (TW); Chia-Te Chou, New Taipei City (TW); Kou-Hsien Lu, New Taipei City (TW); Chun-Wei Wang, New Taipei City (TW); Yu-Yen Chen, New Taipei City (TW)

(73) Assignee: WISTRON CORPORATION, New Taipei City (TW)

(21) Appl. No.: 13/553,826

(22) Filed: Jul. 20, 2012

(30) Foreign Application Priority Data
Apr. 3, 2012 (TW) 101111866

(51) Int. Cl. G06F 3/042

(52) U.S. Cl. 345/175

(57) ABSTRACT

An optical touch sensing apparatus configured to sense a touch around a surface is provided. The optical touch sensing apparatus includes a plurality of optical unit sets respectively defining a plurality of virtual planes. Each of the optical unit sets includes a plurality of optical units, and each optical unit of each optical unit set includes a light source and an image capturing device. The light source emits a detecting light towards the corresponding virtual plane, and the image capturing device captures an image along the corresponding virtual plane. When an object intersects any of the virtual planes, the object reflects the detecting light transmitted in the virtual plane into a reflected light. The image capturing device corresponding to the virtual plane detects the reflected light to obtain information of the object.

### CROSS-REFERENCE TO RELATED APPLICATION

This application claims the priority benefit of Taiwan application serial no. 101111866, filed on Apr. 3, 2012. The entirety of the above-mentioned patent application is hereby incorporated by reference herein and made a part of this specification.

### BACKGROUND OF THE INVENTION

1. Field of the Invention

The invention relates to a touch sensing apparatus. More particularly, the invention relates to an optical touch sensing apparatus.

2. Description of Related Art

Keys, keyboards, or mice often serve as conventional user interfaces for controlling electronic apparatuses. With the advance in science and technology, new user interfaces become more and more user-friendly and accessible. For instance, a touch control interface successfully allows a user to manage an apparatus by intuitively selecting an icon or item displayed on a screen of the apparatus.

However, the conventional touch control interface that permits the user to directly select the icon or item on the screen is frequently applied to an apparatus with a relatively small screen because the user often watches images on the screen at a distance from the screen if the screen size is relatively large. Consequently, fingers of the user at a distance from the screen cannot be in contact with the screen, and thus the user cannot select the icon or item on the screen and cannot perform the function corresponding to the selected icon or item through the conventional touch control interface.

For instance, the conventional touch control interface is apparently hard applicable to a smart TV. In particular, users are accustomed to watching the TV at a distance from the TV, and hence it is rather inconvenient for the users to approach the TV in order to perform certain functions. Additionally, since the cursor-moving function cannot be performed through the conventional touch control interface in most cases, users often complete a selection action by touching the screen through the conventional touch control interface.

The smart TV offers a variety of functions (e.g., web-page navigation and text input) which a conventional remote controller having limited keys cannot support. Thus, it has been proposed to operate the smart TV through a tablet PC, while the tablet PC is costly. Users may also use an electromagnetic-type stylus to operate the smart TV. Nonetheless, the dependence on the stylus still results in user inconvenience. Hand gesture control is another option to users. However, since the hand gesture tracking and recognition technology has not reached the sufficient level of stability, it is rather difficult to accomplish mass text input with hand gestures.

### SUMMARY OF THE INVENTION

The invention is directed to an optical touch sensing apparatus capable of distinguishing the direct touch of an object from the near hover of the object.

In an embodiment of the invention, an optical touch sensing apparatus configured to sense a touch around a surface is provided. The optical touch sensing apparatus includes a plurality of optical unit sets respectively defining a plurality of virtual planes. Each of the optical unit sets includes a plurality of optical units, and each optical unit of each optical unit set includes a light source and an image capturing device. The light source emits a detecting light towards the corresponding virtual plane, and the image capturing device captures an image along the corresponding virtual plane. When an object intersects any of the virtual planes, the object reflects the detecting light transmitted in the virtual plane into a reflected light. The image capturing device corresponding to the virtual plane detects the reflected light to obtain information of the object. A first virtual plane of the virtual planes is located between a second virtual plane of the virtual planes and the surface.

Based on the above, in the optical touch sensing apparatus described in the embodiments of the invention, the optical unit sets are applied to form the first virtual plane and the second virtual plane. The first virtual plane is located between the second virtual plane and the surface. Therefore, when an object interests the second virtual plane and the first virtual plane, it can be concluded that the object is in direct contact with the surface; when the object intersects the second virtual plane but not the first virtual plane, it can be concluded that the object approaches the surface but is not in contact with the surface (i.e., hovers above and near the surface). Thereby, the optical touch sensing apparatus is capable of distinguishing the direct touch of the object from the near hover of the object.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a schematic three-dimensional view illustrating an optical touch sensing apparatus according to an embodiment of the invention.

FIG. 2 is a schematic three-dimensional view illustrating the optical unit depicted in FIG. 1.

FIG. 3 is a schematic top view illustrating the optical touch sensing apparatus depicted in FIG. 1.

FIG. 4A and FIG. 4B are respectively schematic side views illustrating the optical touch sensing apparatus depicted in FIG. 1 in an object near suspending state and an object direct contact state.

FIG. 5 is a schematic side view illustrating an optical touch sensing apparatus according to another embodiment of the invention.

FIG. 6 is a schematic side view illustrating an optical touch sensing apparatus according to yet another embodiment of the invention.

FIG. 7 is a block diagram illustrating the optical touch sensing apparatus depicted in FIG. 1.

### DESCRIPTION OF EMBODIMENTS

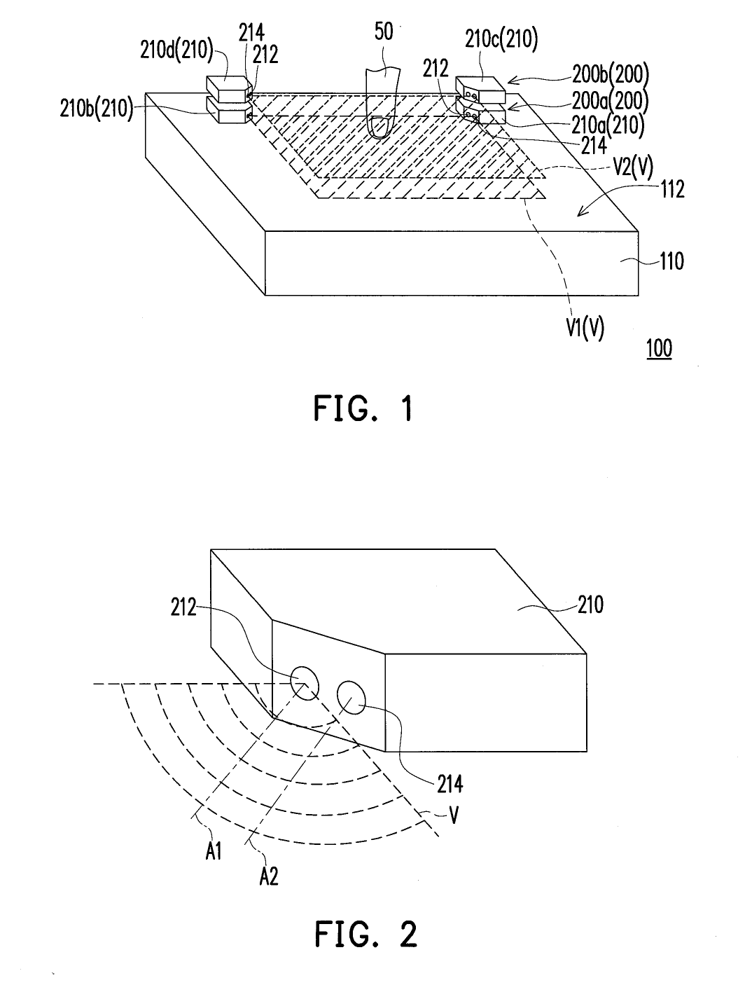

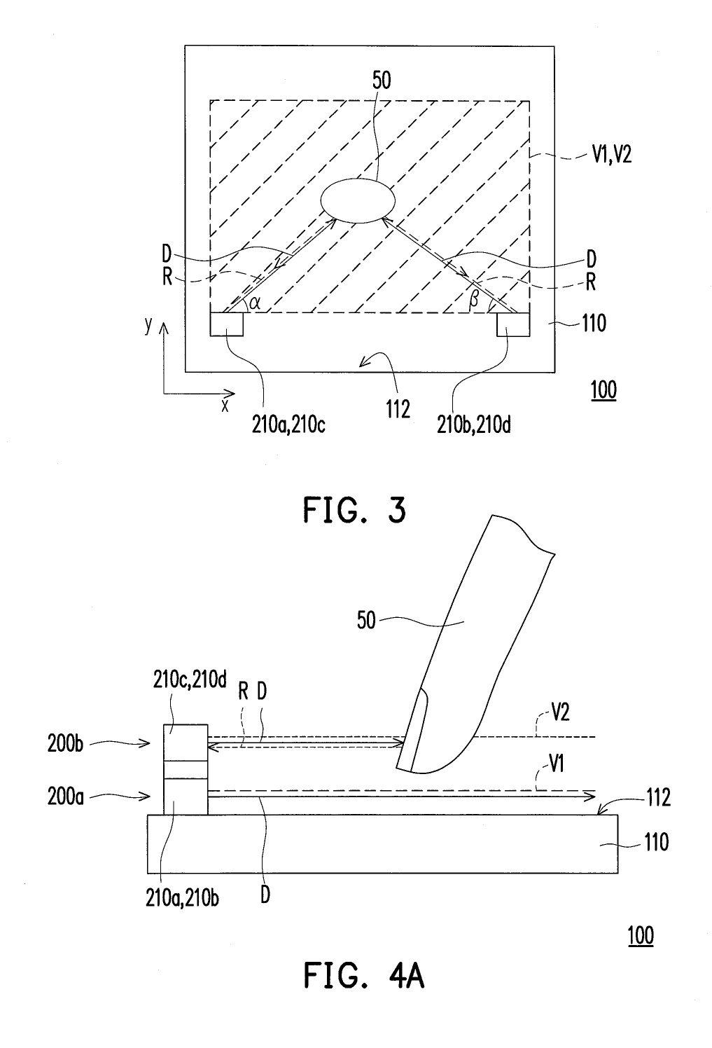

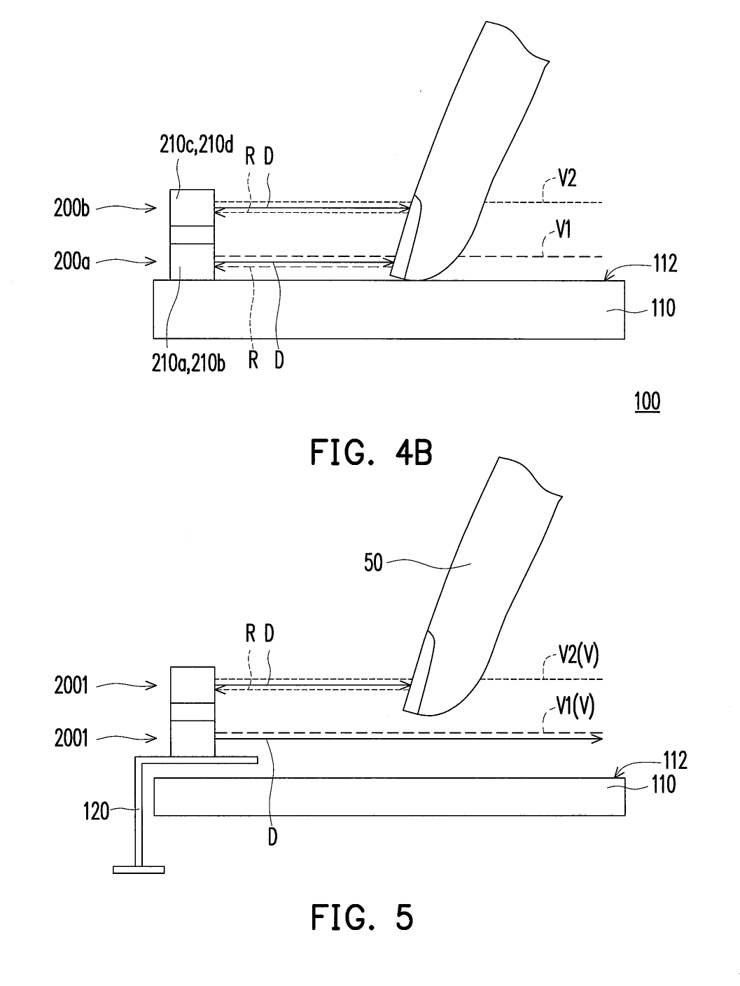

FIG. 1 is a schematic three-dimensional view illustrating an optical touch sensing apparatus according to an embodiment of the invention. FIG. 2 is a schematic three-dimensional view illustrating the optical unit depicted in FIG. 1. FIG. 3 is a schematic top view illustrating the optical touch sensing apparatus depicted in FIG. 1. FIG. 4A and FIG. 4B are respectively schematic side views illustrating the optical touch sensing apparatus depicted in FIG. 1 in an object near suspending state and an object direct contact state. With reference to FIG. 1 to FIG. 3, FIG. 4A, and FIG. 4B, the optical touch sensing apparatus 100 described in the present embodiment serves to sense a touch around a surface 112. In the present embodiment, the surface 112 is a surface of a touch platform 110, for instance. The touch platform 110 is a tea table, a table, a cushion, a mat, or any other proper object. That is, the surface 112 is a surface of the tea table, a table top, a surface of the cushion, a surface of the mat, or any other planar surface (e.g., a surface of a wall, a ground, and so on).

The optical touch sensing apparatus 100 includes a plurality of optical unit sets 200 disposed around the surface 112. In FIG. 1, two optical unit sets 200a and 200b are exemplarily depicted. The optical unit sets 200 respectively define a plurality of virtual planes V. In FIG. 1, the optical unit sets 200a and 200b respectively define the virtual planes V1 and V2, for instance. In the virtual planes V, the virtual plane V1 is located between the virtual plane V2 and the surface 112. In the present embodiment, the virtual planes V are substantially parallel to each other, and the virtual planes V are all parallel to the surface 112.

Each of the optical unit sets 200 includes a plurality of optical units 210. For instance, the optical unit set 200a includes optical units 210a and 210b, and the optical unit set 200b includes optical units 210c and 210d. Each optical unit 210 of each of the optical unit sets 200 includes a light source 212 and an image capturing device 214. The light source 212 emits a detecting light D towards the corresponding virtual plane V, and the image capturing device 214 captures an image along the corresponding virtual plane V. According to the present embodiment, the light source 212 emits the detecting light D along the corresponding virtual plane V. Particularly, in the present embodiment, the light sources 212 of the optical units 210a and 210b of the optical unit set 200a emit the detecting light D along the virtual plane V1, and the image capturing devices 214 of the optical units 210a and 210b of the optical unit set 200a capture an image along the virtual plane V1. Similarly, the light sources 212 of the optical unit set 200b emit the detecting light D towards the virtual plane V2, and the image capturing devices 214 of the optical unit set 200b captures an image along the virtual plane V2.

According to the present embodiment, the image capturing device 214 is a line sensor, e.g., a complementary metal oxide semiconductor (CMOS) sensor, a charge coupled device (CCD), or any other appropriate image sensor. The light source 212 is, for instance, a laser generator, light emitting diode (LED), or any other appropriate light-emitting device. The detecting light D may be visible or invisible. According to the present embodiment, the detecting light D is infrared light, for instance. In the present embodiment, as shown in FIG. 2, optical axes A1 of the light sources 212 and optical axes A2 of the image capturing devices 214 of the optical units 210 of each of the optical unit sets 200 are substantially on the corresponding virtual planes V. Thereby, the light sources 212 indeed emit the detecting light D along the corresponding virtual planes V, and the image capturing devices 214 indeed capture images along the corresponding virtual planes V. In particular, the optical axes A1 and the optical axes A2 of the light sources 212 and the image capturing devices 214 of the optical units 210a and 210b are substantially on the corresponding virtual planes V1, and the optical axes A1 and the optical axes A2 of the light sources 212 and the image capturing devices 214 of the optical units 210c and 210d are substantially on the corresponding virtual planes V2.

When an object 50 intersects any of the virtual planes V, the object 50 reflects the detecting light D transmitted in the virtual plane V into a reflected light R. The image capturing device 214 corresponding to the virtual plane V detects the reflected light R to obtain information of the object 50, e.g., position information. In the present embodiment, the object 50 is, for instance, a user's finger, a stylus, or any other appropriate object.

As indicated in FIG. 4A, when the object 50 intersects the virtual plane V2 but not the virtual plane V1, i.e., the object 50 is suspended in the air and approaches the surface 112, the object 50 reflects the detecting light D transmitted in the virtual plane V2 into the reflected light R transmitted in the virtual plane V2. The image capturing devices 214 of the optical units 210c and 210d can thereby detect the reflected light R. On the other hand, the object 50 does not reflect the detecting light D transmitted in the virtual plane V1, and therefore the image capturing devices 214 of the optical units 210a and 210b do not detect any reflected light. Thereby, the optical touch sensing apparatus 100 is capable of determining that the object 50 is suspended in the air and approaches the surface 112 without contacting the surface 112. Further, as indicated in FIG. 4B, when the object 50 intersects both the virtual plane V2 and the virtual plane V1, the object 50 reflects the detecting light D transmitted in the virtual plane V2 into the reflected light R transmitted in the virtual plane V2. The image capturing devices 214 of the optical units 210c and 210d can thereby detect the reflected light R transmitted in the virtual plane V2. The object 50 also reflects the detecting light D transmitted in the virtual plane V1 into the reflected light R transmitted in the virtual plane V1, and the image capturing devices 214 of the optical units 210a and 210b can thereby detect the reflected light R transmitted in the virtual plane V1. At this time, the optical touch sensing apparatus 100 is capable of determining that the object 50 is in direct contact with the surface 112.

In the present embodiment, the optical unit sets 200 are exemplarily disposed on the surface 112, which should not be construed as a limitation to the invention. Namely, the optical unit sets 200 are able to sense the touch around the surface 112 even though the optical unit sets 200 are not disposed on the surface 112. For instance, in another embodiment shown in FIG. 5, the optical unit sets 2001 are separated from the surface 112, while the virtual planes V of the optical unit sets 2001 can still be used to detect the object 50. Additionally, when the optical unit sets 2001 are separated from the surface 112, the optical unit sets 2001 can be supported by a holder 120 or any other support component. For instance, an end of the holder 120 may be disposed on the floor or fixed to a wall, and the other end of the holder 120 serves to fix the optical unit set 2001. In another embodiment, the holder 120 may also be fixed onto the touch platform 110.

In the previous embodiment, the optical unit sets 200 are disposed around the surface 112, which should not be construed as a limitation to the invention. The optical unit sets 200 may be located above the surface 112 or may be separated from the surface 112 (shown in FIG. 5), and the virtual planes V of the optical unit sets 200 can still be used to detect the object 50.

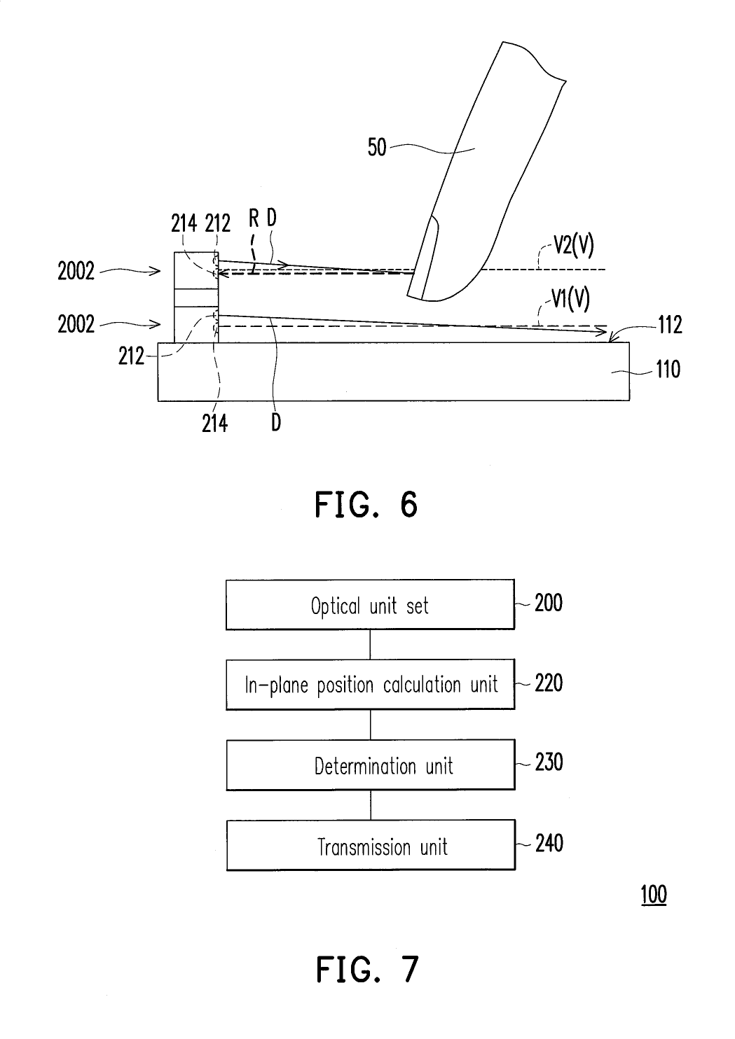

In the previous embodiment, the light sources 212 emit the detecting light D along the corresponding virtual planes V, and the optical axes A1 of the light sources 212 of the optical units 210a and 210b are substantially on the corresponding virtual plane V1. However, the direction of the light sources 212 is not limited in the invention. According to another embodiment, as shown in FIG. 6, the light sources 212 of the optical unit sets 2002 are located above the corresponding virtual planes V, and the light sources 212 emit the detecting light D along the oblique down direction. Namely, the optical axes of the light sources 212 intersect the virtual planes V. In FIG. 6, the solid lines representing the detecting light D substantially overlap the optical axes of the light sources 212, for instance. The object 50 irradiated by the detecting light D can reflect the detecting light D into the reflected light R, and the reflected light R can be detected by the image capturing devices 214 of the corresponding optical sets 2002. Likewise, the light sources 212 may also be located below the corresponding virtual planes V. As long as the light sources 212 emit the detecting light D toward the corresponding virtual planes V, the object 50 irradiated by the detecting light D can reflect the detecting light D into the reflected light R, and the reflected light R can be detected by the image capturing devices 214 of the corresponding optical unit sets.

With reference to FIG. 1 to FIG. 3, FIG. 4A, and FIG. 4B, as described in the present embodiment, the optical touch sensing apparatus 100 with the simple structure is capable of distinguishing the direct touch of the object 50 from the near hover of the object 50. The action of object 50 hovering above and near the surface 112 and moving along a direction substantially parallel to the surface 112 may be configured to move the cursor in the frame. This is similar to the movement of a mouse. By contrast, the action of the object 50 directly contacting the surface 112 may be configured to select the icon or item in the frame. This is similar to the click-on of a mouse button. As such, the user may operate the optical touch sensing apparatus 100 in an easy manner similar to the way to use a mouse. Besides, the simple structure of the optical touch sensing apparatus 100 is conducive to cost reduction.

Since the optical touch sensing apparatus 100 described in the present embodiment is operated according to the optical sensing principle, the stylus is not required by the optical touch sensing apparatus 100. Namely, the user may simply operate the optical touch sensing apparatus 100 with his or her fingers or with use of the stylus or any other appropriate object. This effectively facilitates the use of the optical touch sensing apparatus 100. Moreover, the optical touch sensing apparatus 100 serves to determine whether an object intersects with the virtual plane V, so that the determination process is simple and stable.

In the present embodiment, the surface 112 is different from a display surface of a screen. For instance, the touch platform 110 is independent from the screen. Thereby, the optical touch sensing apparatus 100 is capable of remotely controlling icons or items on the display surface of the screen at a distance from the screen. For instance, the smart TV may be remotely controlled by the optical touch sensing apparatus 100 at a distance from the smart TV, and such remote control may be similar to the control of a mouse for browsing web-pages. Besides, through calculating the specific position on the surface 112 where the object 50 touches, the optical touch sensing apparatus 100 may also perform the text or number entry functions on the smart TV, and such functions are similar to those accomplished by a keyboard.

In another embodiment, the surface 112 (as shown in FIG. 1) may also be the display surface of the screen. For example, the optical touch sensing apparatus 100 is applicable to a portable electronic apparatus with a small-sized display surface, and the portable electronic apparatus may be operated through a user's finger hovering over the screen or touching the screen.

In the present embodiment, the distance from the virtual planes V1 to the surface 112 may have an appropriate value, such that the image capturing devices 214 of the optical units 210a and 210b may detect the reflected light R with sufficient intensity at the time the object 50 touches the surface 112, and the optical touch sensing apparatus 100 can then determine that the object 50 intersects the virtual planes V1.

FIG. 7 is a block diagram illustrating the optical touch sensing apparatus depicted in FIG. 1. With reference to FIG. 1, FIG. 3, and FIG. 7, in the present embodiment, the optical touch sensing apparatus 100 further includes an in-plane position calculation unit 220. The in-plane position calculation unit 220 calculates a position of the object 50 on the virtual planes V through triangulation according to the information of the object 50 obtained by the image capturing devices 214 and determines whether the object 50 intersects the virtual planes V. Particularly, the in-plane position calculation unit 220 may calculate the x and y coordinates of the object 50 on the virtual planes V in the x-y coordinate system according to light-incident angles α and β at which the reflected light R enters the image capturing devices 214 (as shown in FIG. 3). Besides, the in-plane position calculation unit 220 may determine whether the object 50 intersects the virtual planes V by the intensity of the reflected light R.

The optical touch sensing apparatus 100 in the present embodiment further includes a determination unit 230. The determination unit 230 makes conclusion according to a calculation result of the in-plane position calculation unit 220. Specifically, when the in-plane position calculation unit 220 calculates and determines that the object 50 intersects the virtual plane V2 but not the virtual plane V1, the determination unit 230 concludes that the object 50 is suspended above the surface 112 and is not in contact with the surface 112. On the other hand, when the in-plane position calculation unit 220 calculates and determines that the object 50 intersects the virtual plane V2 and the virtual plane V1, the determination unit 230 concludes that the object 50 is in contact with the surface 112.

In the present embodiment, the optical touch sensing apparatus 100 further includes a transmission unit 240. The transmission unit 240 transmits a command to a host according to the calculation result of the in-plane position calculation unit 220 and a determination result of the determination unit 230. Here, the host is a computer, a smart TV, a screen, a multimedia player, or a host of any other electronics, for instance. When the determination unit 230 concludes that the object 50 is suspended above the surface 112 and the in-plane position calculation unit 220 calculates and determines that the object 50 moves along the virtual plane V2, the command is to move a cursor in a frame generated by the host. This is similar to the movement of a mouse. By contrast, when the determination unit 230 concludes that the object 50 is in contact with the surface 112, the command is to select an icon or item in the frame generated by the host. This is similar to the click-on of a mouse button.

According to the present embodiment, the transmission unit 240 is a wireless transmission unit and transmits signals to the host via wireless transmission. Thereby, the optical touch sensing apparatus 100 is capable of remotely controlling the host at a distance and is not subject to length of a transmission line. According to another embodiment, the transmission unit 240 may also be coupled to the host via a signal transmission line, i.e., the transmission unit 240 may be a wire transmission module.

To sum up, in the optical touch sensing apparatus described in the embodiments of the invention, the optical unit sets are applied to form the virtual planes V1 and V2. The virtual plane V1 is located between the virtual plane V2 and the surface. Therefore, when an object interests the virtual plane V1 and the virtual plane V2, it can be concluded that the object is in direct contact with the surface; when the object intersects the virtual plane V2 but not the virtual plane V1, it can be concluded that the object approaches the surface but is not in contact with the surface (i.e., hovers above and near the surface). Thereby, the optical touch sensing apparatus is capable of distinguishing the direct touch of the object from the near hover of the object.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. An optical touch sensing apparatus configured to sense a touch around a surface, the optical touch sensing apparatus comprising:
a plurality of optical unit sets respectively defining a plurality of virtual planes, each of the optical unit sets comprising a plurality of optical units, each of the optical units of each of the optical unit sets comprising:
a light source emitting a detecting light toward one of the virtual planes corresponding to the light source; and
an image capturing device capturing an image along the corresponding virtual plane, wherein when an object intersects any of the virtual planes, the object reflects the detecting light transmitted in the virtual plane into a reflected light, and the image capturing device corresponding to the virtual plane detects the reflected light to obtain information of the object;
wherein a first virtual plane of the virtual planes is located between a second virtual plane of the virtual planes and the surface.

2. The optical touch sensing apparatus as recited in claim 1, wherein the virtual planes are substantially parallel to each other, and the virtual planes are all parallel to the surface.

3. The optical touch sensing apparatus as recited in claim 1, wherein optical axes of the light sources and optical axes of the image capturing devices of the optical units of each of the optical unit sets are substantially in the corresponding virtual plane.

4. The optical touch sensing apparatus as recited in claim 1, wherein the surface is different from a display surface of a screen.

5. The optical touch sensing apparatus as recited in claim 1, further comprising an in-plane position calculation unit, the in-plane position calculation unit calculating a position of the object on the virtual planes through triangulation according to the information of the object obtained by the image capturing devices and determining whether the object intersects the virtual planes.

6. The optical touch sensing apparatus as recited in claim 1, further comprising a determination unit, the determination unit making conclusion according to a calculation result of the in-plane position calculation unit, wherein the determination unit concludes that the object is suspended above the surface and is not in contact with the surface when the in-plane position calculation unit calculates and determines that the object intersects the second virtual plane but not the first virtual plane, and the determination unit concludes that the object is in contact with the surface when the in-plane position calculation unit calculates and determines that the object intersects the second virtual plane and the first virtual plane.

7. The optical touch sensing apparatus as recited in claim 6, further comprising a transmission unit, the transmission unit transmitting a command to a host according to the calculation result of the in-plane position calculation unit and a determination result of the determination unit, wherein the command is to move a cursor in a frame when the determination unit concludes that the object is suspended above the surface and the in-plane position calculation unit calculates and determines that the object moves along the second virtual plane, and the command is to select an icon or item in the frame when the determination unit concludes that the object is in contact with the surface.

8. The optical touch sensing apparatus as recited in claim 7, wherein the transmission unit is a wireless transmission unit.

9. The optical touch sensing apparatus as recited in claim 7, wherein the transmission unit is coupled to the host through a signal transmission line.

10. The optical touch sensing apparatus as recited in claim 1, wherein the image capturing device is a line sensor.

11. The optical touch sensing apparatus as recited in claim 10, wherein line sensor is a complementary metal oxide semiconductor sensor or a charge coupled device.

12. The optical touch sensing apparatus as recited in claim 1, wherein the light sources are laser generators or light emitting diodes.

13. The optical touch sensing apparatus as recited in claim 1, further comprising a touch platform having the surface.

14. The optical touch sensing apparatus as recited in claim 13, wherein the touch platform is independent from a screen.

15. The optical touch sensing apparatus as recited in claim 1, wherein the optical unit sets are disposed beside the surface.
